(19) United States
(12) Patent Application Publication
(10) Pub. No.: US 2010/0283398 A1
(43) Pub. Date: Nov. 11, 2010

(54) DRIVING DEVICE OF LIGHTING APPARATUS

(76) Inventor: Wen-Jyh SAH, Tainan City (TW)

Correspondence Address: BIRCH STEWART KOLASCH & BIRCH, PO BOX 747, FALLS CHURCH, VA, 22040-0747, US

(21) Appl. No.: 12/503,446

(22) Filed: Jul. 15, 2009

(30) Foreign Application Priority Data
Jul. 16, 2008 (TW) 097212702

(51) Int. Cl. H05B 37/02

(52) U.S. Cl. 315/210

(57) ABSTRACT

A driving device of a lighting apparatus includes a control circuit and a power conversion circuit. The power conversion circuit is electrically connected to the control circuit, a first light-emitting diode (LED) unit, and a second LED unit. The power conversion circuit has a switching unit, an electrical isolating unit, and a transformer unit. The electrical isolating unit has an electrical isolating side and a non-electric-isolating side, which is coupled to the electrical isolating side. The non-electrical isolating side is electrically connected to the switching unit. The transformer unit, which is electrically connected to the electrical isolating side, has a first output terminal and a second output terminal. The first output terminal is electrically connected to a positive electrode of the first LED unit and a negative electrode of the second LED unit. The second output terminal is electrically connected to a negative electrode of the first LED unit and a positive electrode of the second LED unit.

### CROSS REFERENCE TO RELATED APPLICATIONS

This Non-provisional application claims priority under 35 U.S.C. §119(a) on Patent Application No(s). 097212702 filed in Taiwan, Republic of China on Jul. 16, 2008, the entire contents of which are hereby incorporated by reference.

### BACKGROUND OF THE INVENTION

1. Field of Invention

The present invention relates to a driving device and, in particular, to a driving device of a lighting apparatus.

2. Related Art

The light-emitting diode (LED) is a semiconductor element that is usually used as the signal light or the light source of the outdoor display panel. The LED is called the new type of light source in 21st century for having high efficiency, long lifespan, and hard to be damaged. These are the advantages the conventional light sources do not have.

FIG. 1 is a schematic view of a driving device 1 of a conventional lighting apparatus. With reference to FIG. 1, the driving device 1 includes a power factor correction circuit 11, a DC-to-DC power conversion circuit 12, a DC-to-AC power conversion circuit 13, and a plurality of LEDs 14. The power factor correction circuit 11 converts the public electricity to a 400V DC power.

The DC-to-DC power conversion circuit 12 is electrically connected to the power factor correaction circuit 11 for adjusting the 400V DC power to step down and outputting a DC power relatively lower than 400V. The DC-to-AC power conversion circuit 13 is electrically connected to the DC-to-DC power conversion circuit 12 and the LED 14, and converts the outputted DC power from the DC-to-DC power conversion circuit 12 for driving the AC power of the LED 14 to light up the LED 14.

However, the LEDs 14 of the conventional lighting apparatus are connected to each other in series. Therefore, in practice, the illumination is implemented by only half of the AC power cycle. Furthermore, the ground of the public electricity and the ground of the load (LED 14) are isolated in the DC-to-DC power conversion circuit 12, such that when people touch the grounding terminal of the load, they will not get an electric shock because the human body and the ground of the public electricity form a loop.

Recently, manufactures have developed a driving device with a two-stage structure, in which a DC-to-DC power conversion circuit is removed, such that the DC power outputted from the power factor correction circuit is directly transmitted to the DC-to-AC power conversion circuit. Thus, although the cost of the DC-to-DC power conversion circuit is removed, the isolating function originally provided by the DC-to-DC conversion circuit will have to be transferred to the DC-to-AC power conversion circuit.

Usually the manufactures uses an isolating transformer to function as a step-up transformer of the DC-to-AC power conversion circuit, and this makes the size of the converter increase in practice. Therefore, it is an important subject to provide a driving device of a lighting apparatus that can enhance the power efficiency and is able to reduce the increasing size of the DC-to-AC power conversion circuit and its increasing cost.

### SUMMARY OF THE INVENTION

In view of the foregoing, the present invention is to provide a driving device of a lighting apparatus, which is able to enhance the power efficiency. In addition, when a plurality of DC-to-AC power conversion circuits are needed, the driving device may reduce the increasing size of the DC-to-AC power conversion circuit as well as the cost thereof.

To achieve the above, the present invention discloses a driving device of a lighting apparatus, which drives a first LED unit and a second LED unit. The driving device includes a control circuit and a power conversion circuit. The control circuit generates at least one switching control signal. The power conversion circuit is electrically connected to the control circuit, first LED unit, and second LED unit. The power conversion circuit includes a switching unit, an electrical isolating unit, and at least one transformer unit. The switching unit outputs at least one first power signal according to a DC signal and the switching signal. The electrical isolating unit generates a second power signal according to the first power signal and includes a non-electrical isolating side and an electrical isolating side coupled with the non-electrical isolating side. The non-electrical isolating side is electrically connected to the switching unit. The transformer unit is electrically connected to the electrical isolating side of the electrical isolating unit and includes a first output terminal and a second output terminal. The first output terminal is electrically connected to a positive electrode of the first LED unit and a negative electrode of the second LED unit. The second output terminal is electrically connected to a negative electrode of the first LED unit and a positive electrode of the second LED unit. The transformer unit generates a driving signal according to the second power signal for driving the first LED unit and the second LED unit.

As mentioned above, in the driving device of the lighting apparatus according to the present invention, the positive electrode of the first LED unit driven by the driving device is electrically connected to the negative electrode of the second LED unit, and the negative electrode of the first LED unit is electrically connected to the positive electrode of the second LED unit. Compared to the prior art, the present invention may utilize the positive half cycle and the negative half cycle of the AC power to drive the LED unit, respectively, for increasing the power efficiency. Furthermore, when a plurality of DC-to-AC power conversion circuits are needed, the electrical isolating unit may help to reduce the increasing size of the DC-to-AC conversion circuit and the cost thereof.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a schematic view of a conventional driving device of a lighting apparatus;

FIG. 2 is a structural schematic view of a driving device of a light apparatus according to a preferred embodiment of the present invention;

FIGS. 3A and 3B are schematic views showing various aspects of the connections between the first LED units and the second LED units in the driving device according to the preferred embodiment of the present invention;

FIGS. 4A to 4C are schematic views showing various aspects of the electrical isolating circuits and transformer circuits in the driving device of the lighting apparatus according to the preferred embodiment of the present invention;

FIGS. 5A to 5C are schematic views showing various aspects of the driving device of the lighting apparatus according to the preferred embodiment of the present invention, further including a sequential control circuit; and

FIGS. 6A and 6B are schematic views showing various aspects of the driving device of the lighting apparatus according to the preferred embodiment of the present invention, further including a test circuit.

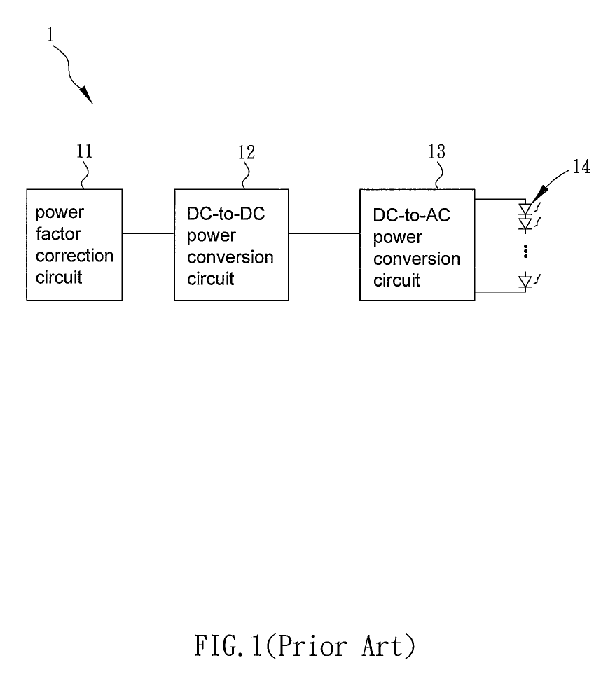

### DETAILED DESCRIPTION OF THE INVENTION

The present invention will be apparent from the following detailed description, which proceeds with reference to the accompanying drawings, wherein the same references relate to the same elements.

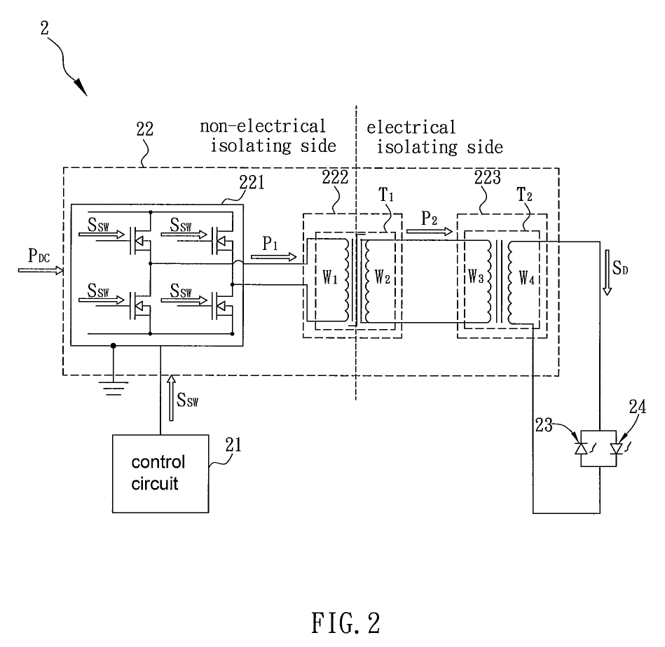

FIG. 2 is a schematic view of a driving device 2 of a lighting apparatus. With reference to FIG. 2, the driving device 2 drives a first light-emitting diode (LED) 23 and a second LED unit 24, and includes a control circuit 21 and a power conversion circuit 22. The control circuit 21 generates at least one switching control signal S_{SW}. The power conversion circuit 22 is electrically connected to the control circuit 21, the first LED unit 23, and the second LED unit 24.

The power conversion circuit 22 has a switching unit 221, an electrical isolating unit 222, and at least one transformer unit 223. The switching unit 221 outputs at least one first power signal P₁ according to a DC signal P_{DC} and the switching signal S_{SW}. In practice, the switching unit 221 is, for example but not limited to, a half-bridge switching circuit, a full-bridge switching circuit, or a push-pull switching circuit. The switching unit 221 includes at least one bipolar junction transistor (BJT), at least one field effect transistor (FET), or at least one diode that mainly implements the action of turn-on or turn-off according to the switching control signal and converts the DC signal P_{DC} to the first power signal P₁.

The electrical isolating unit 222 has a non-electrical isolating side and an electrical isolating side coupled with the non-electrical isolating side. The non-electrical isolating side is electrically connected to the switching unit 221 and generates a second power signal P₂ according to the first power signal P₁. In the embodiment, the electrical isolating unit 222 includes an isolating transformer T₁ that includes a first winding W₁ located on the non-electrical isolating side and at least one second winding W₂ located on the electrical isolating side, where the first winding W₁ is coupled with the second winding W₂.

The transformer unit 223 is electrically connected to the electrical isolating side of the electrical isolating unit 222, and includes a first output terminal and a second output terminal. The positive electrode of the first LED unit 23 and the negative electrode of the second LED unit 24 are electrically connected to the first output terminal, respectively. The negative electrode of the first LED unit 23 and the positive electrode of the second LED unit 24 are electrically connected to the second output terminal, respectively. The transformer unit 223 generates a driving signal S_{D} according to the second power signal P₂ for driving the first LED unit 23 and the second LED unit 24. In the embodiment, the transformer unit 223 may be a step-up circuit or a step-down circuit; it may also be a winding designed as a 1:1 circuit according to actual needs.

In addition, the transformer unit 223 includes at least one transformer T₂, which may be a step-up transformer or a step-down transformer. In the embodiment, the transformer T₂ has a third winding W₃ and at least one fourth winding W₄ coupled with the third winding W₃. The fourth winding W₄ has a first output terminal and the second output terminal that are electrically connected to the first LED unit 23 and the second LED unit 24, respectively. In the embodiment, the above-mentioned DC signal P_{DC}, first power signal P₁, and second power signal P₂ are voltage signals. Alternatively, the first power signal P₁ and the second power signal P₂ are AC signals.

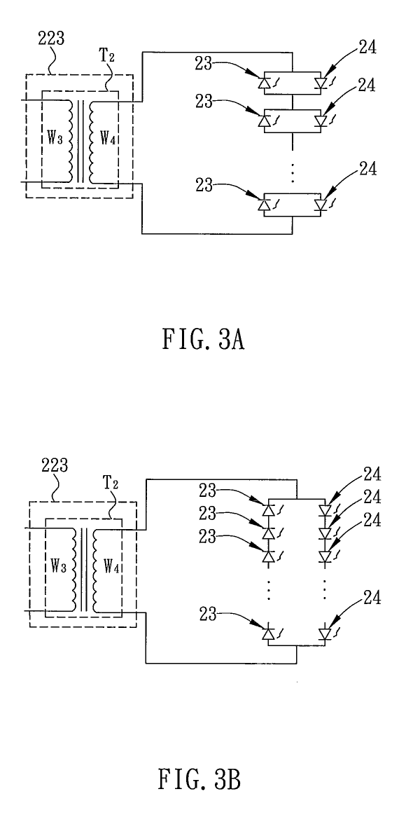

Additionally, it is noted that in the embodiment, a first LED unit 23 and a second LED unit 24 are used as examples. However, the present invention may also adopt the aspect of a plurality of first LED units 23 and a plurality of second LED units 24. FIGS. 3A and 3B show an LED unit in various aspects. With reference to FIG. 3A, the first LED unit 23 and the second LED unit 24 are inversely connected in parallel, and then many pairs of the first and second LED units 23 and 24 are connected in series. With reference to FIG. 3B, a plurality of first LED units 23 and a plurality of second LED units 24 are connected in series, respectively, and then the connected first LED units 23 and the connected second LED units 24 are inversely connected in parallel.

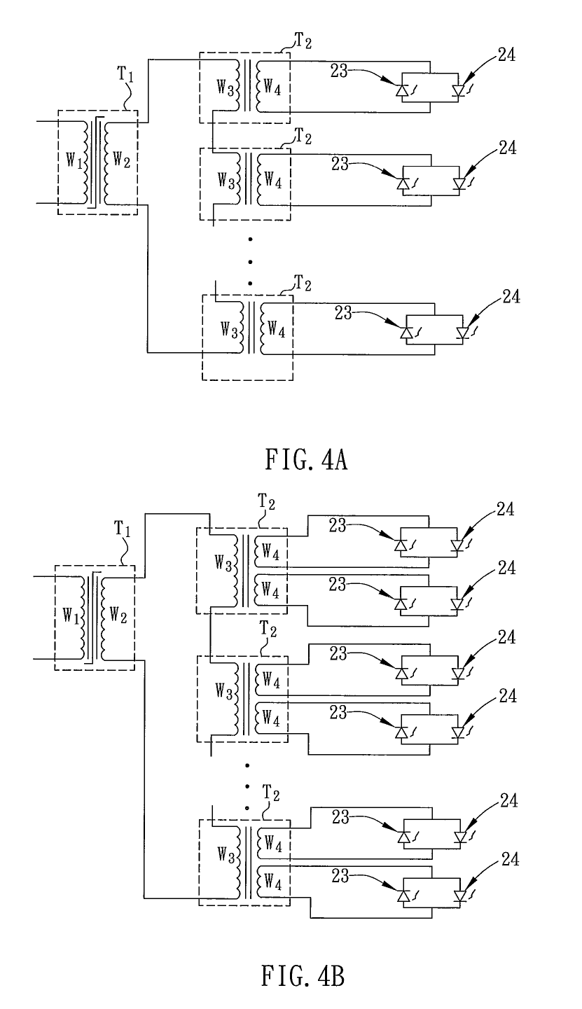

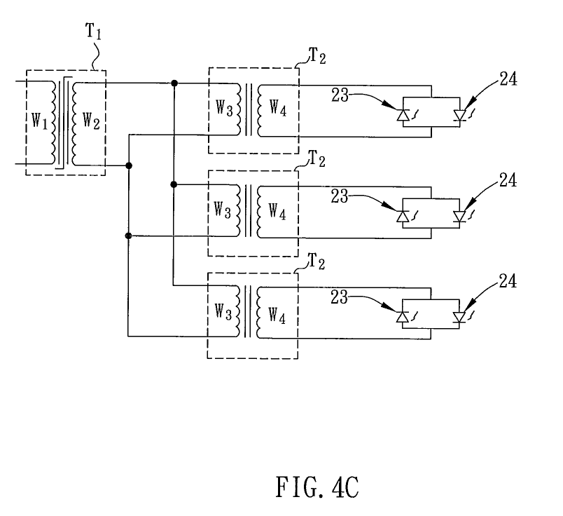

In practice, the structure of the transformer unit 223 may have various aspects according to different product needs or actual demands. FIGS. 4A to 4C are examples illustrating three application structures of the transformer unit 223.

With reference to FIG. 4A, when the transformer unit 223 includes a plurality of transformers T₂, each transformer T₂ has a third winding W₃ and a fourth winding W₄. The third windings W₃ are electrically connected to each other in series, and each of the fourth windings W₄ is electrically connected to at least one pair of a first LED unit 23 and a second LED unit 24. As shown in FIG. 4B, in each transformer T₂, the third winding W₃ is coupled with two fourth windings W₄, and each fourth winding W₄ is electrically connected to one pair of the first LED unit 23 and the second LED unit 24. Please refer to FIG. 4C, the third windings W₃ of the transformers T₂ are electrically connected to each other in parallel.

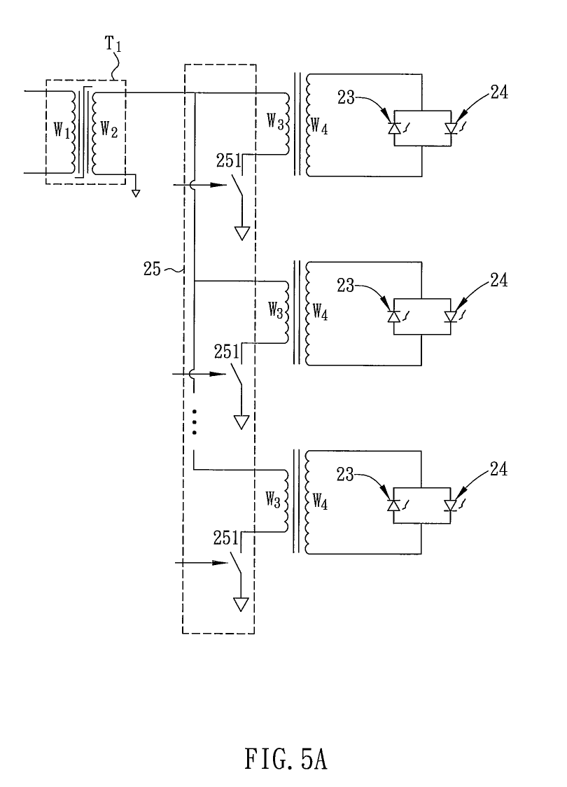

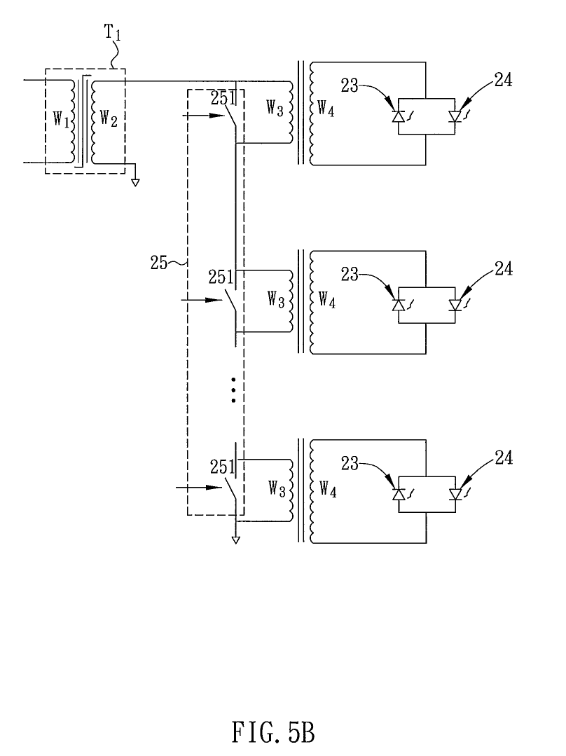

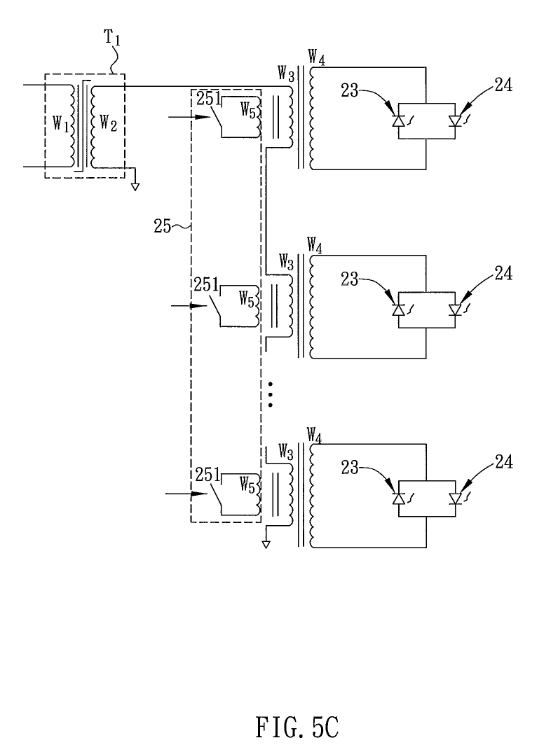

Please refer to FIG. 5A, in the embodiment, the driving device 2 further includes a sequential control unit 25, which is electrically connected to and sequentially controls the transformers T₂. The sequential control unit 25 includes a plurality of reset switches 251 that are coupled with the third windings W₃ of the corresponding transformers T₂, respectively. Each of the reset switches 251 is turned on or off according to a control signal.

In practice, the reset switch 251 and the third winding W₃ may be connected in series as shown in FIG. 5A or in parallel as shown in FIG. 5B. It may also control the transformer T₂ via a fifth winding W₅ as shown in FIG. 5C, in which each fifth winding W₅ is coupled with one corresponding third winding W₃ and is connected to one corresponding reset switch 251.

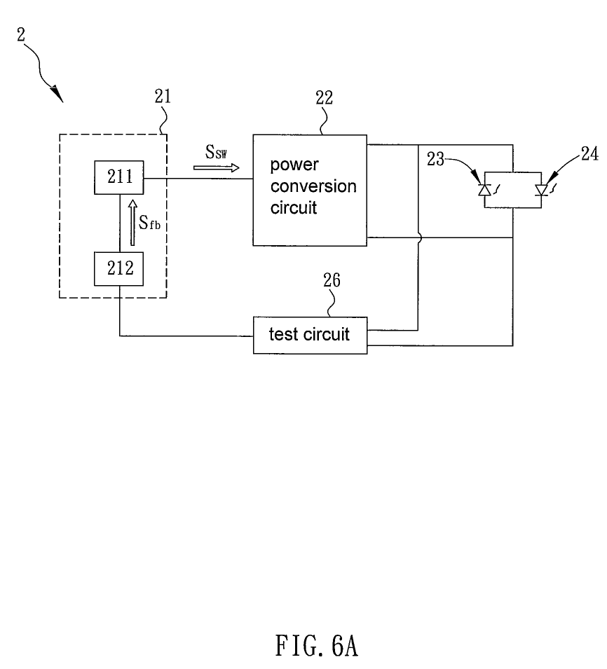

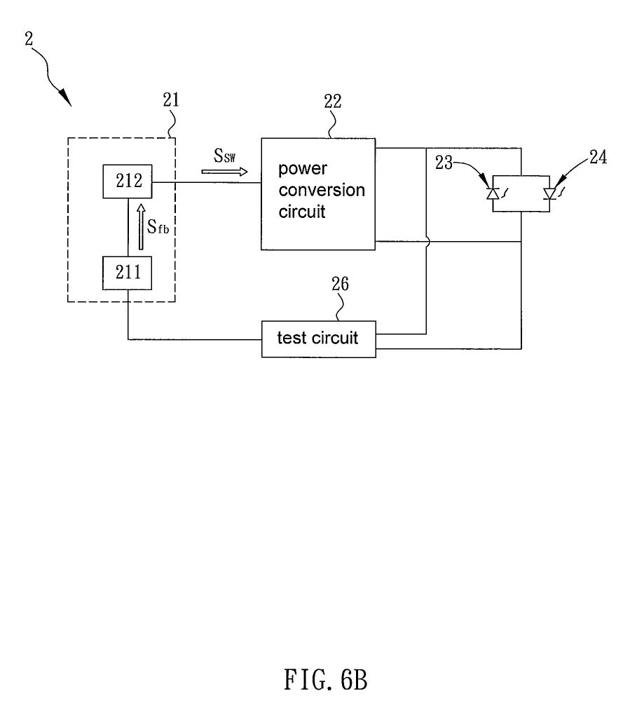

Referring to FIG. 6A, in the embodiment, the driving device 2 further includes a test circuit 26, which is electrically connected to the first LED unit 23 and the control circuit 21. In the embodiment, the control circuit 21 includes a control unit 211 and a signal isolating unit 212 electrically connected to the control unit 211. The test circuit 26 is electrically connected to the signal isolating unit 212 of the control circuit 21. The signal isolating unit 212 generates a feedback signal S_{fb} according to a current signal or a voltage signal from the test circuit 26, and the feedback signal S_{fb} is outputted to the control unit 211 for generating the switching control signal S_{SW}.

FIG. 6B is a schematic view of another test circuit 26. The test circuit 26 is electrically connected to the control unit 211 of the control circuit 21. The control unit 211 generates a feedback signal S_{fb} according to a current signal or a voltage signal from the test circuit 26, and outputs the feedback signal S_{fb} to the signal isolating unit 212 for generating the switching control signal S_{SW}.

It is noted that the current test circuit and voltage test circuit does not have to exist in the driving device 2 at the same time. That is, the driving device 2 may only include either the current test circuit or the voltage test circuit according to the actual needs.

To sum up, in the driving device of the lighting apparatus according to the present invention, the positive electrode of the first LED unit driven by the driving device is electrically connected to the negative electrode of the second LED unit and the negative electrode of the first LED unit is electrically connected to the positive electrode of the second LED unit. Compared to the prior art, the present invention may use the positive half cycle or the negative half cycle of the AC power to drive the LED unit, for increasing the power efficiency. Furthermore, when a plurality of DC-to-AC power conversion circuits are needed, the electrical isolating unit may reduce the increasing size of the DC-to-AC conversion circuit and the cost thereof.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A driving device for driving a first light-emitting diode (LED) unit and a second LED unit, the driving device comprising:
a control circuit generating at least one switching control signal; and
a power conversion circuit electrically connected to the control circuit, the first LED unit, and the second LED unit, the power conversion circuit comprising:
a switching unit outputting at least one first power signal according to a DC signal and the switching control signal;
an electrical isolating unit having a non-electrical isolating side and an electrical isolating side coupled with the non-electrical isolating side, wherein the non-electrical isolating side is electrically connected to the switching unit and the electrical isolating unit generates a second power signal according to the first power signal; and
at least one transformer unit electrically connected to the electrical isolating side of the electrical isolating unit and having a first output terminal and a second output terminal, wherein the first output terminal is electrically connected to a positive electrode of the first LED unit and a negative electrode of the second LED unit, the second output terminal is electrically connected to a negative electrode of the first LED unit and a positive electrode of the second LED unit, and the transformer unit generates a driving signal according to the second power signal for driving the first LED unit and the second LED unit.

2. The driving device according to claim 1, wherein the electrical isolating unit of the power conversion circuit comprises an isolating transformer having a first winding located on the non-electrical isolating side and a second winding located on the electrical isolating side, and the first winding is coupled with the second winding.

3. The driving device according to claim 1, wherein the transformer unit of the power conversion circuit comprises at least one transformer, the transformer has a third winding and at least one fourth winding coupled with the third winding, and the fourth winding has the first output terminal and the second output terminal.

4. The driving device according to claim 3, wherein the transformer is a step-up transformer or a step-down transformer.

5. The driving device according to claim 3, wherein when the transformer unit of the power conversion circuit has a plurality of transformers, the third windings are connected to each other in series or in parallel.

6. The driving device according to claim 5 further comprising a sequential control unit coupled with the transformers and orderly controlling the transformers.

7. The driving device according to claim 6, wherein the sequential control unit comprises a plurality of reset switches and each of the reset switches is coupled with the corresponding third winding.

8. The driving device according to claim 7, wherein the sequential control unit further comprising a plurality of fifth windings, and each of the fifth windings is correspondingly coupled with one of the third windings and one of the reset switches.

9. The driving device according to claim 8, wherein the reset switches and the third windings are connected to each other in series or in parallel.

10. The driving device according to claim 1, further comprising a test circuit electrically connected to the first LED unit and the control circuit.

11. The driving device according to claim 10, wherein the control circuit comprises a control unit and a signal isolating unit electrically connected to the control unit.

12. The driving device according to claim 11, wherein the test circuit is electrically connected to the signal isolating unit of the control circuit, and the signal isolating unit generates a feedback signal according to a current signal or a voltage signal outputted from the test circuit, and outputs the feedback signal to the control unit for generating the switching control signal.

13. The driving device according to claim 11, wherein the test circuit is electrically connected to the control unit of the control circuit, and the control unit generates a feedback signal according to a current signal or a voltage signal outputted from the test circuit, and outputs the feedback signal to the signal isolating unit for generating the switching control signal.
